(19) United States
(12) Patent Application Publication
(10) Pub. No.: US 2026/0089611 A1
(43) Pub. Date: Mar. 26, 2026

(54) LOCATION-BASED SYSTEM INFORMATION ACQUISITION

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/321,104

(22) Filed: Sep. 5, 2025

Related U.S. Application Data
(60) Provisional application No. 63/697,189, filed on Sep. 20, 2024.

(51) Int. Cl. H04W 48/16; H04W 64/00; H04W 84/06

(52) U.S. Cl. CPC H04W 48/16; H04W 64/006; H04W 84/06

(57) ABSTRACT

Disclosed are signalling design and procedure signalling and acquisition procedures for location-based system information (SI) based on the relation between the intended area of the SI and a UE's location. The disclosed procedure facilitates the delivery, request, and use of location-based SI in NTN where the location-based SI targets an area smaller than the cell coverage of the NTN and for UEs to receive SI intended for an intended geographic area. A UE may identify an intended service area for SI transmitted by a base station based on intended area information associated with the SI. The UE determines whether the UE is located within the intended service area for the SI. The UE acquires the SI if the UE is located within the intended service area for the SI. Otherwise, the UE does not acquire the SI if the UE is located outside the intended service area for the SI.

### CROSS-REFERENCE TO RELATED APPLICATIONS

This application claims the benefit of priority from U.S. Provisional Application No. 63/697,189 entitled “LOCATION-BASED SYSTEM INFORMATION ACQUISITION,” filed Sep. 20, 2024, which is incorporated herein by reference in its entirety.

### TECHNICAL FIELD

This disclosure relates generally to a wireless communication system, and more particularly to techniques for a base station to signal location-based system information and for a user equipment to signal and acquire location-based system information.

### BACKGROUND

3GPP (Third-Generation Partnership Project) has developed technical specifications and standards to define the new 5G radio-access technology, known as 5G NR (New Radio) and the upcoming technology currently coined “6G.” In 3GPP Release 17 specification, 5G NR introduces support for vertical functionality of a non-terrestrial network (NTN). An NTN provides non-terrestrial NR access to a user equipment (UE) by means of an NTN payload, e.g. a satellite, and an NTN Gateway as specified in 3GPP TS 38.300 v18.0.0 (5G; NR; NR and NG-RAN Overall Descriptions; Stage 2) and 3GPP TS 38.331 v18.0.0 (5G; NR; Radio Resource Control (RRC); Protocol specification). The NTN payload transparently forwards the radio protocol received from the UE over the service link (i.e. wireless link between the NTN payload and UE) to the NTN Gateway via the feeder link (i.e. wireless link between the NTN Gateway and the NTN payload) and vice-versa. With its capabilities to deliver wide coverage and reliable connectivity, NTN is envisioned to provide ubiquitous service availability and continuity. For instance, NTN can support communication services in unserved areas beyond the reach of conventional terrestrial networks (TN), in underserved areas with limited communication services, for devices and passengers on board moving platforms, and in future railway/maritime/aeronautical communication scenarios, etc. To support NTN in 5G NR, features are continuously being introduced or enhanced to accommodate the nature of providing radio access from NTN, such as large cell coverage, long propagation delay, and non-static cell/satellite that are different from TN.

In TN, a serving cell may periodically broadcast system information (SI) to all UEs within a cell coverage area or may broadcast or transmit SI to UEs on demand. SI may include basic information for UEs to access a cell in a network (e.g., master information block (MIB), system information block 1 (SIB1)), as well as additional cell-specific information for the UEs to achieve some functionality (e.g., other SI including SIBs other than SIB1). The SIBs other than SIB1 are not mandatory for the UEs to receive before accessing the cell. The TN may transmit these SIBs by periodically broadcasting on downlink shared channel (DL-SCH), by broadcasting on-demand on DL-SCH (i.e. upon explicit request from UEs), or by transmitting in a dedicated manner on DL-SCH to UEs in RRC_CONNECTED mode.

In NTN, the satellite footprint and the serving cell typically cover an area that is usually much larger than a TN cell coverage area. The NTN may broadcast SI that is be location-specific and intended for a broadcast area smaller than an NTN cell coverage area such that the broadcast information may be specific to UEs within the intended broadcast area. For example, the PWS may be specific to a country based on a geo-fencing procedure. To facilitate the delivery of location-based SI, it is desired for the NTN serving cell to transmit on demand location-based SI and for a UE to request and/or acquire location-based SI based on the relationship between the intended area of the SI and the location of the UE.

While the background section provides a motivation for the present disclosure, the description set forth in the background section should not be assumed to be prior art merely because it is set forth in the background section. Rather, the background section may describe aspects or embodiments of the present disclosure.

### SUMMARY

An aspect of the present disclosure provides for a user equipment (UE) in a wireless network. The UE includes a processor configured to identify an intended service area for SI transmitted by a base station based on intended area information associated with the SI. The processor is also configured to determine whether the UE is located within the intended service area for the SI. The processor is further configured to cause the UE to acquire the SI in response to the UE being determined to be located within the intended service area for the SI. Otherwise, the processor is configured to cause the UE to refrain from acquiring the SI in response to the UE being determined to be located outside the intended service area for the SI.

In one embodiment of the UE, the SI includes one or more system information blocks (SIBs). The intended area information for the SI includes a mapping between each of the SIBs and one or more corresponding intended area IDs, where each of the one or more intended area IDs corresponding to an SIB represents an intended geographic service area of the SIB.

In one embodiment of the UE, to identify the intended service area for SI and to determine whether the UE is located within the intended service area for the SI, the processor is configured to determine that the intended service area for the SI is unavailable or a location of the UE is unavailable. The processor is also configured to determine that the SI is broadcast by the base station. The processor is further configured to cause the UE to acquire the SI.

In one embodiment of the UE, to determine whether the UE is located within the intended service area for the SI, the processor is configured to determine that the UE is located within the intended service area for the SI. The processor is also configured to determine that the SI is not broadcast by the base station. The processor is further configured to trigger a request to the base station to transmit the SI.

In one embodiment of the UE, to trigger the request to the base station to transmit the SI, the processor is configured to trigger the request using a random access procedure.

In one embodiment of the UE, to identify the intended service area for SI and to determine whether the UE is located within the intended service area for the SI, the processor is configured to determine that the intended service area for the SI is unavailable or a location of the UE is unavailable. The processor is also configured to determine that the SI is not broadcast by the base station. The processor is further configured to trigger a request to the base station to transmit the SI.

In one embodiment of the UE, to cause the UE to acquire the SI responsive to the UE being located within the intended service area for the SI, the processor is configured to determine that a configuration restriction prevents the UE from acquiring the SI when the SI is broadcast by the base station. The processor is also configured to cause the UE to receive the SI by dedicated signalling from the base station.

In one embodiment of the UE, to determine the configuration restriction prevents the UE from acquiring the SI, the processor is configured to determine that the UE is in a connected mode with the base station and to determine that the UE does not have a search space to monitor paging or to acquire the SI.

In one embodiment of the UE, the SI includes a system information block (SIB) for a public warning system (PWS) message.

An aspect of the present disclosure provides for a base station in a wireless network. The base station includes a processor configured to determine that a UE cannot acquire SI broadcast by the base station due to a configuration restriction. The SI is associated with an intended service area. The processor is also configured to determine whether location information of the UE is available. The processor is further configured to determine whether the UE is located within the intended service area for the SI in response to the location information of the UE being available. The processor is further configured to cause the base station to transmit the SI by dedicated signalling to the UE in response to the UE being determined to be located within the intended service area for the.

In one embodiment of the base station, to determine whether the location information of the UE is available, the processor is configured to determine that the location information of the UE is unavailable. The processor is also configured to cause the base station to transmit the SI by dedicated signalling to the UE.

An aspect of the present disclosure provides for a method performed by a UE in a wireless network. The method includes the UE identifying an intended service area for SI transmitted by a base station based on intended area information associated with the SI. The method also includes the UE determining whether the UE is located within the intended service area for the SI. The method further includes the UE acquiring the SI in response to the UE being determined to be located within the intended service area for the SI. Otherwise, the method includes the UE refraining from acquiring the SI in response to the UE being determined to be located outside the intended service area for the SI.

In one embodiment of the method, the SI includes one or more system information blocks (SIBs). The intended area information for the SI includes a mapping between each of the SIBs and one or more corresponding intended area IDs, where each of the one or more intended area IDs corresponding to an SIB represents an intended geographic service area of the SIB.

In one embodiment of the method, when identifying the intended service area for the SI and determining whether the UE is located within the intended service area for the SI, the method includes the UE determining that the intended service area for the SI is unavailable or a location of the UE is unavailable. The method also includes the UE determining that the SI is broadcast by the base station. The method further includes the UE acquiring the SI.

In one embodiment of the method, when determining whether the UE is located within the intended service area for the SI, the method includes the UE determining that the UE is located within the intended service area for the SI. The method also includes the UE determining that the SI is not broadcast by the base station. The method further includes the UE triggering a request to the base station to transmit the SI.

In one embodiment of the method, triggering the request to the base station to transmit the SI, the method includes the UE triggering the request using a random access procedure.

In one embodiment of the method, when identifying the intended service area for the SI and determining whether the UE is located within the intended service area for the SI, the method includes the UE determining that the intended service area for the SI is unavailable or a location of the UE is unavailable. The method also includes the UE determining the SI is not broadcast by the base station. The method further includes the UE triggering a request to the base station to transmit the SI.

In one embodiment of the method, when acquiring SI responsive to the UE being located within the intended service area for the SI, the method includes the UE determining a configuration restriction prevents the UE from acquiring the SI when the SI is broadcast by the base station. The method also includes the UE receiving the SI by dedicated signalling from the base station.

In one embodiment of the method, when determining the configuration restriction prevents the UE from acquiring the SI, the method includes the UE determining the UE is in a connected mode with the base station and determining the UE does not have a search space to monitor paging or to acquire the SI.

In one embodiment of the method, the SI includes a system information block (SIB) for a public warning system (PWS) message.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows a procedure for a BS to deliver location-based SI via dedicated signalling (e.g., unicast signalling) to a UE in accordance with an embodiment.

FIG. 5 shows a procedure for a UE to request location-based SI from a BS in accordance with an embodiment.

FIG. 6 shows a procedure for a UE to acquire location-based SI from a BS in accordance with an embodiment.

FIG. 7 shows an example process 700 for a UE to acquire location-based SI in accordance with an embodiment.

FIG. 8 shows an example process 800 for a BS to deliver location-based SI in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic that has dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

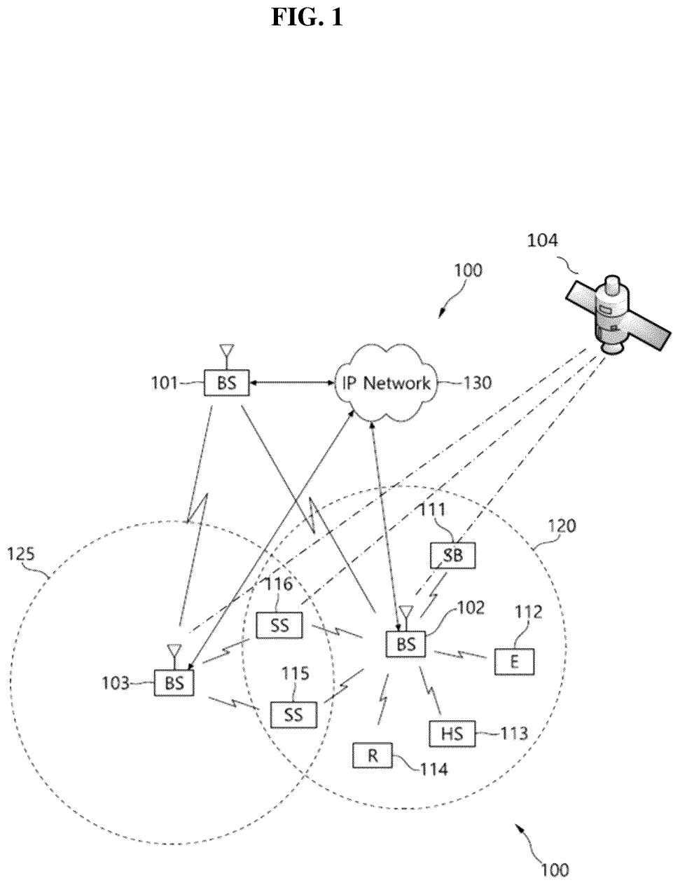

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the BS 101, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

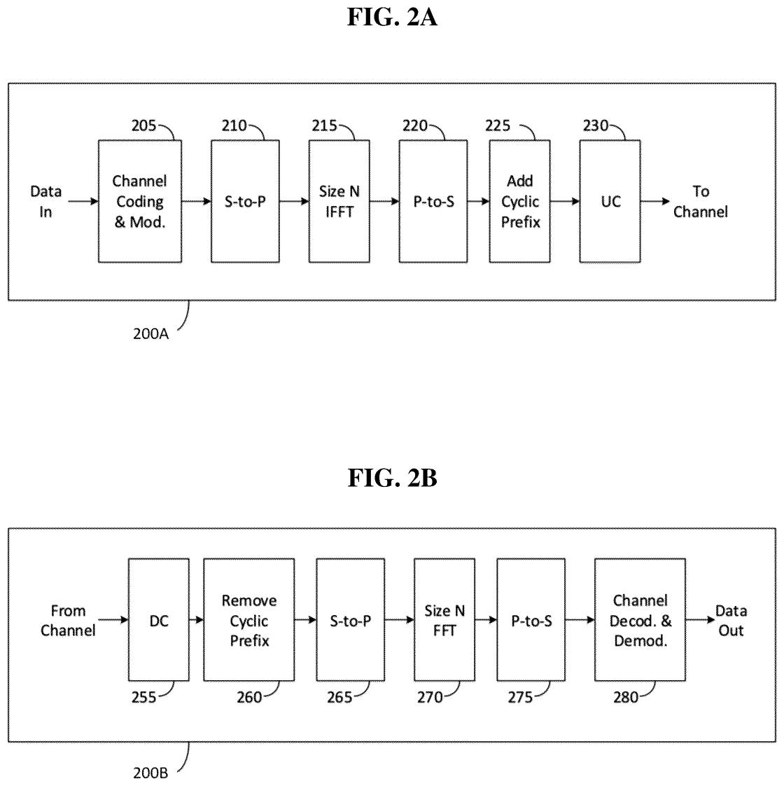

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

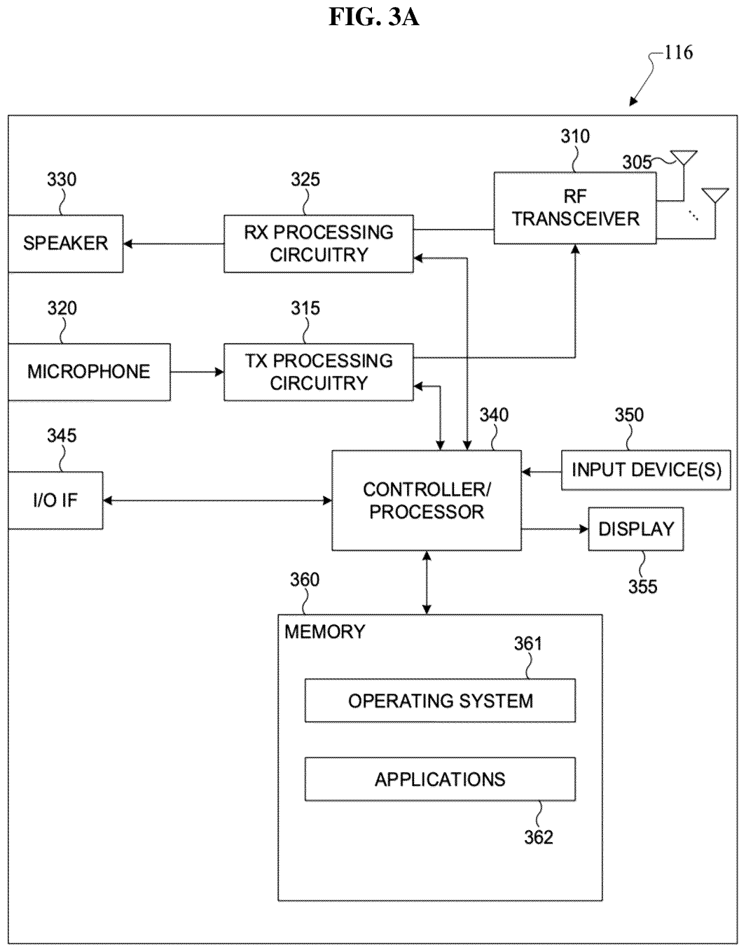

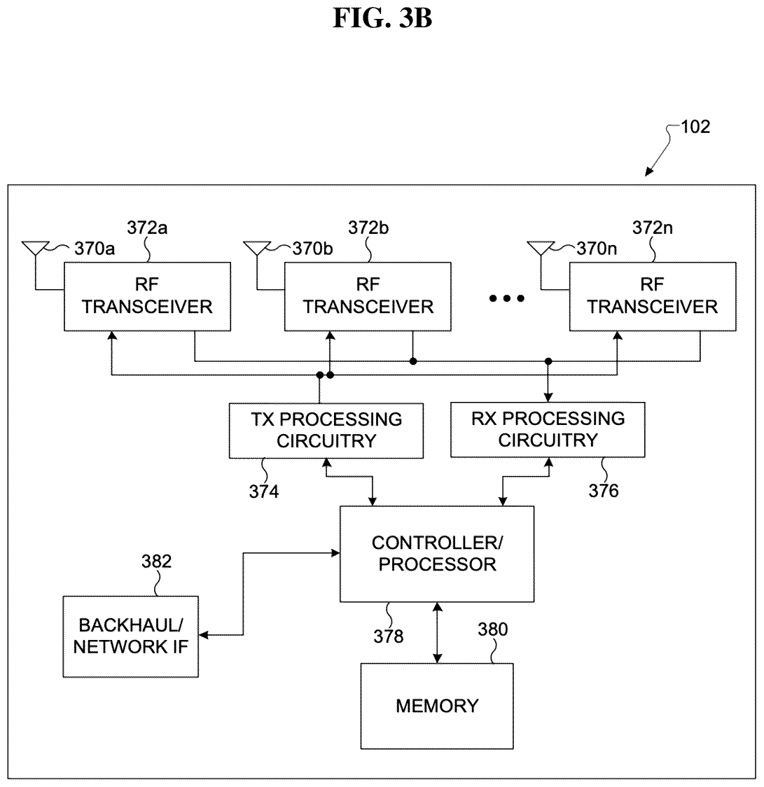

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 is coupled to the processor 340, directly or through intervening elements. The main processor 340 is also capable of executing other processes and programs resident in the memory 360 as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main processor 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting other processes in wireless communication systems as described in embodiments of the present disclosure. In some embodiments, the controller/processor 378 supports communications between entities, such as web real-time communication (web RTC). The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning the uplink transmission to a certain frequency and establishing the downlink transmission using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one TX processing circuitry 374 or RX processing circuitry 376 per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For 5G and the next generation cellular systems such as 6G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP, TS 38.300 v18.0.0, 5G; NR; NR and NG-RAN Overall Description; Stage 2; ii) 3GPP TS 38.331 v18.0.0, 5G; NR; Radio Resource Control (RRC) protocol specification; iii) 3GPP TS 38.321 v18.0.0, NR; Medium Access Control (MAC) protocol specification; iv) 3GPP, TS 38.304 v18.2.0, NR; User Equipment (UE) procedures in Idle mode and RRC Inactive state; and v) 3GPP, TS 38.306 v18.2.0, NR; User Equipment (UE) radio access capabilities.

In NTN, the NTN payload may be in a geosynchronous orbit (GSO) (i.e. earth-centered orbit at approximately 35,786 kilometers above Earth's surface and synchronized with Earth's rotation), or in a non-geosynchronous orbit (NGSO) (i.e. Low Earth Orbit (LEO) at altitude approximately between 300 km and 1,500 km or Medium Earth Orbit (MEO) at altitude approximately between 7000 km and 25,000 km). Depending on different NTN payloads, three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams); and
Earth-moving: provisioned by beam(s) whose coverage area slides over the Earth surface (e.g., the case of NGSO satellites generating fixed or non-steerable beams).

As such, due to different properties of GSO and NGSO, NTN may support different types of cells and cell coverage. For example, with NGSO satellites, the gNB may provide either quasi-Earth-fixed cell coverage or Earth-moving cell coverage, while gNB operating with GSO satellite may provide Earth fixed cell coverage. A UE may support specific features or functionalities to enable radio access specific to an NTN payload/cell.

An NTN cell may broadcast SI (e.g., public warning system (PWS) warning message, TN coverage area information, NTN assistance information, multicast/broadcast service (MBS) relevant information, etc.). The SI may be area-specific or may be intended for UEs at a certain geographic area. For example, PWS provides a service that allows the NTN to distribute warning messages on behalf of public authority. PWS may include earthquake and tsunami warning system (ETWS), commercial mobile alert service (CMAS), and warning messages that are specific to a country. When an NTN cell is large and its cell coverage spans across multiple countries, the NTN may target the warning message to only a part of the cell. In another example, NTN assistance information included in SI may contain satellite information and/or cell access restriction information that are area dependent. In yet another example, TN coverage area information included in SI may be different for different parts of the NTN cell when the TN coverage area information include different TN cells neighbouring different parts of the NTN cell. In yet another example, MBS relevant information (e.g., multicast service, broadcast service) may be area dependent when the services and configurations provided for different parts of the NTN cell are different.

Disclosed are signalling and acquisition procedures for location-based SI. The signalling and acquisition procedure may be based on the relation between the intended area of the SI and the UE location. For example, if UE is outside the intended area of a SI, there is no need for the NTN to deliver the corresponding SIB to the UE or for the UE to request the corresponding SIB from the NTN. In one aspect of the present disclosure, a network delivers an area-specific SI (also referred to as location-based SI) targeted for a UE based on the UE location and the intended area of the SI. In another aspect of the present disclosure, a UE transmits a request for an on-demand area-specific SI to a network based on the UE location and the intended area of the SI. In another aspect of the present disclosure, a UE performs SI acquisition based on the UE location and the intended area of the SI.

The UE may indicate its capability for supporting location-based SI acquisition (e.g., for periodically broadcast SI, for targeted SI transmission, and/or for on-demand SI by SI request). In one embodiment, the capability may be indicated per frequency range (FR) (e.g. FR1. FR2, etc.), per UE, per band, per duplex mode (FDD/TDD), or per band combination. For example, the capability may be indicated with or without any difference between FR1 and FR2, or between TDD and FDD. In one embodiment, the UE may signal this capability in UE capability information message or any other RRC message. In one embodiment, the UE may support location-based SI acquisition without signaling to the network.

In one aspect, a BS may transmit location-based SI in a dedicated manner (e.g., by RRCReconfiguration message) to a UE based on the UE location and the intended area of the SI. For example, when a UE cannot acquire the broadcast SI due to configuration restriction (e.g., UE in RRC_CONNECTED mode has an active bandwidth part (BWP) with no common search space to monitor paging or acquire SI (e.g., PWS message), UE operating in Sidelink, etc.), the BS may decide to transmit the SI by UE-dedicated signalling (e.g., by RRCReconfiguration message) if the UE is located inside the intended area of the SI. Otherwise, the BS may decide not to transmit the SI to the UE in dedicated signalling (e.g., by RRCReconfiguration message) if the UE is located outside the intended area of the SI.

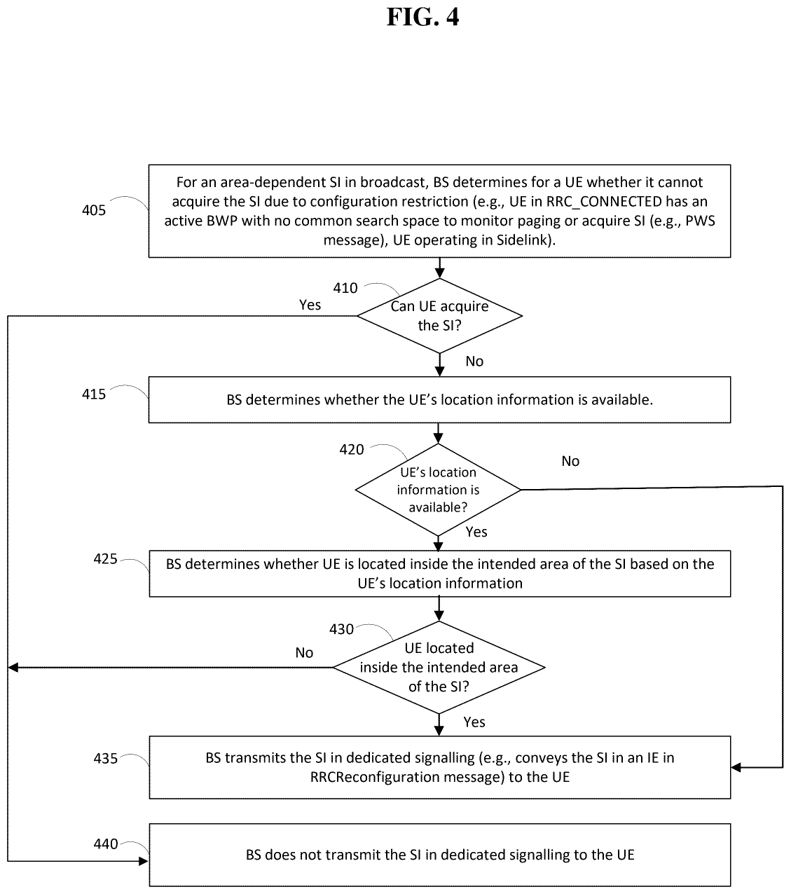

FIG. 4 shows a procedure for a BS to deliver location-based SI via dedicated signalling (e.g., unicast signalling) to a UE in accordance with an embodiment.

At operation 405, for an area-dependent SI in broadcast, the BS determines whether a UE cannot acquire the SI due to configuration restriction (e.g., UE in RRC_CONNECTED mode has an active BWP with no common search space to monitor paging or acquire SI (e.g., PWS message), UE operating in Sidelink, etc.).

At operation 410, if the BS determines the UE can acquire the SI due to configuration restriction, the procedure proceeds to operation 440.

At operation 440, the BS does not transmit the SI in dedicated signalling to the UE since the UE can acquire the SI in broadcast.

Otherwise, at the operation 410, if the BS determines the UE cannot acquire the SI, the procedure proceeds to operation 415.

At operation 415, the BS determines whether the UE's location information is available. In one embodiment, the BS may obtain UE's location information by requesting/triggering location report in radio resource management (RRM) measurement report, in UE assistance information message, and/or by positioning methods.

At operation 420, if the BS determines the UE's location information is available, the procedure proceeds to operation 425.

At operation 425, the BS determines whether the UE is located inside the intended area of the SI based on the UE's location information.

At operation 430, if the BS determines the UE is located inside the intended area of the SI, the procedure proceeds to operation 435 to transmit the SI in dedicated signalling to the UE.

Back at operation 420, if the BS determines the UE's location information is not available, the procedure also proceeds to operation 435 to transmit the SI in dedicated signalling to the UE.

At operation 435, the BS transmits the area-dependent SI in dedicated signalling to the UE. In one embodiment, the BS may transmit the SI in an information element (IE) in an RRCReconfiguration message to the UE.

Otherwise, at operation 430, if the BS determines the UE is located outside the intended area of the SI, the operation proceeds to operation 440, where the BS does not transmit the SI in dedicated signalling to the UE since the UE is outside the area targeted by the SI.

In one aspect, a UE may transmit a request for an on-demand area-specific SI to a network based on the UE location and the intended area of the SI. For example, for location-based SI with broadcast status set to notBroadcasting, a UE in RRC_IDLE/INACTIVE mode may send a SI request to a BS to acquire the SI if the UE determines its location is inside the intended area of the SI. Otherwise, if the UE determines its location is not inside the intended area of the SI, the UE does not send the SI request.

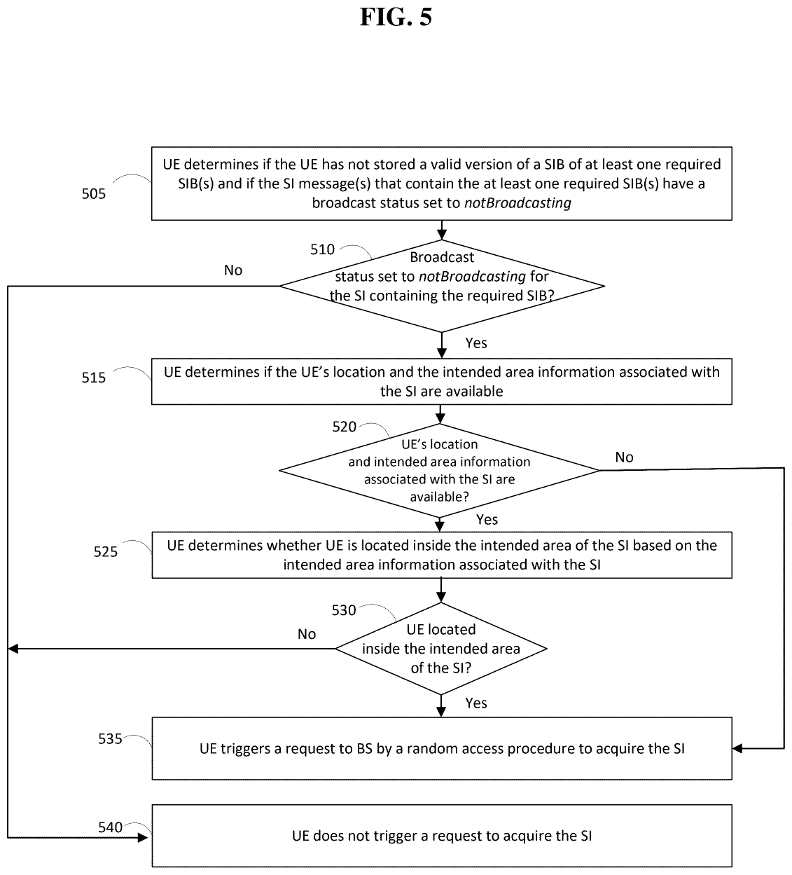

FIG. 5 shows a procedure for a UE to request location-based SI from a BS in accordance with an embodiment.

At operation 505, the UE determines if the UE has not stored a valid version of a SIB of one or several required SIB(s) and if the SI message(s) that contain the at least one required SIB(s) have a broadcast status set to notBroadcasting.

At operation 510, if the UE determines the broadcast status is set to notBroadcasting for the SI message(s) that contain the at least one required SIB(s), the procedure proceeds to operation 515.

Otherwise, if the UE determines the broadcast status is not set to notBroadcasting (i.e., broadcast status is set to Broadcasting) for the SI message(s) that contain the at least one required SIB(s), the procedure proceeds to operation 540, where the UE does not trigger a request to the BS to acquire the SI.

At operation 515, the UE determines if the UE's location and the intended area information associated with the SI are available. In one embodiment, the UE may acquire its location by global navigation satellite system (GNSS). In one embodiment, the UE may acquire the intended area information for the SI in MIB or SIB1 or other SIB(s) (e.g., in si-SchedulingInfo in SIB1). In one embodiment, the intended area information for the SI may be indicated by a mapping relation between each SIB and corresponding one or multiple intended area ID(s). In one embodiment, each intended area ID may represent a geographic area. If one or multiple intended area ID(s) are indicated for a SIB of SI, the SI is intended for the geographic area represented by the intended area ID(s).

In one embodiment, one or more synchronization signal block (SSB) index(es) are indicated as associated with each SI and the corresponding SSB(s) beam is broadcast to certain geographic area(s). The intended area information associated with the SI may be indicated by the SSB index(es) associated with the SI. The UE may determine its location based on selected SSB index(es) when accessing the cell that transmits the SI. For example, the UE may consider it is inside the intended area of the SI if any selected SSB index(es) is the same as one of the SSB index(es) associated with the SI. Alternatively, the UE may consider it is outside the intended area of the SI if none of the selected SSB index(es) is the same as the SSB index(es) associated with the SI.

In one embodiment, the intended area ID and the related geographic area information may be provisioned in universal subscriber identity module (uSIM), or conveyed in SIB (e.g., in MIB or SIB1 or other SIB). For example, the intended geographic area, each identified by an area ID, may be described by circle(s) and/or polygon(s). A circle is indicated by centre coordinates (e.g., reference location) and a radius. The centre coordinates may be signalled as a bit string, in one of the various formats of ellipsoid point defined in 3GPP Specification TS37.355 (e.g., Ellipsoid-Point, Ellipsoid-PointWithUncertaintyCircle, EllipsoidPointWithUncertaintyEllipse, EllipsoidPointWithAltitude, EllipsoidPointWithAltitude AndUncertaintyEllipsoid). The first/leftmost bit of the first octet contains the most significant bit. The radius indicates a distance from the centre coordinates, which may be signalled as an integer value in a unit of meter. A polygon is indicated by a list of polygon points with at least 3 points as defined in 3GPP Specification TS 37.355, where each point is indicated by an ellipsoid point (e.g., Ellipsoid-Point) as defined in 3GPP Specification TS 37.355.

In one embodiment, the intended area ID and the related geographic area may be derived by the UE based on the UE's location, a pre-defined rule of zone area, and/or relevant parameters. For example, each geographic area may be defined as a rectangular zone. The UE may determine the intended area ID for a geographic area based on the UE's location. For example, the broadcast service area ID is calculated by:

$$ID = {y}^{′} \times Nx + {x}^{′} \qquad ( Equation 1 )$$

where
x′=ceil(x/L) mod Nx;
y′=ceil(y W) mod Ny;
x and y are the longitude and latitude of the UE's location;
L, W are the length and width of each zone, respectively; and
Nx, Ny are the number of zones in length and width respectively.
The UE may obtain its location by GNSS. L, W, Nx, and Ny may be pre-configured in MIB or SIB1 or pre-defined in standard specification or provisioned in uSIM.

At operation 520, if the UE determines the UE's location and the intended area information associated with the SI are available, the procedure proceeds to operation 525.

At operation 525, the UE determines whether it is located inside the intended area of the SI based on the UE's location and the intended area information associated with the SI.

At operation 530, if the UE determines it is located inside the intended area of the SI, the procedure proceeds to operation 535 to trigger a request to the BS to acquire the SI.

Back at operation 520, if the UE determines the UE's location or the intended area information associated with the SI are not available, the procedure also proceeds to operation 535 to trigger a request to the BS to acquire the SI.

Otherwise, at operation 530, if the UE determines it is located outside the intended area of the SI, the UE proceeds to operation 540, where the UE does not trigger a request to the BS to acquire the SI since the UE is outside the area targeted by the SI.

At operation 535, the UE triggers a request to the BS by a random access (RA) procedure to acquire the SI. In one embodiment, the BS may configure the UE with dedicated RA resource(s) for SI request(s) (e.g., (in MIB or in SIB1)). The BS may configure the dedicated RA resource(s) for SI request(s) per SI, which may include dedicated preamble index(es), time and/or frequency resources, etc.

If dedicated RA resource for a SI request is available, the UE may perform contention free random access (CFRA) for the SI request. The UE may select a preamble index allocated for the SI the UE wants to request. The UE may transmit the RA preamble (Msg1) using the selected preamble index. Upon receiving the Msg1, the BS knows which SI the UE is requesting based on the RA resource used for Msg1. The BS acknowledges the request by sending the RA response (Msg2) to the UE. The BS then broadcasts the requested SI. Upon receiving the Msg2, the UE may start to acquire the SI by monitoring physical downlink control channel (PDCCH) addressed to system information radio network temporary identifier (SI-RNTI).

If dedicated RA resource for a SI request is not available, the UE may perform contention based random access (CBRA) for the SI request. The UE may transmit Msg1 and may receive Msg2. The UE may transmit a SI request message (e.g., RRCSystemInfoRequest message) that indicates the requested SI in the scheduled transmission message (MSG3). A bitmap may be used with each bit corresponding to a SI message. Upon receiving the SI request, the BS resolves the contention by sending the contention resolution message (Msg4) as an acknowledgement to the UE. The BS then broadcasts the requested SI. Upon receiving the Msg4, UE may start to acquire the SI by monitoring PDCCH addressed to SI-RNTI.

In one aspect, a UE may acquire broadcast area-specific SI based on the UE location and the intended area of the SI.

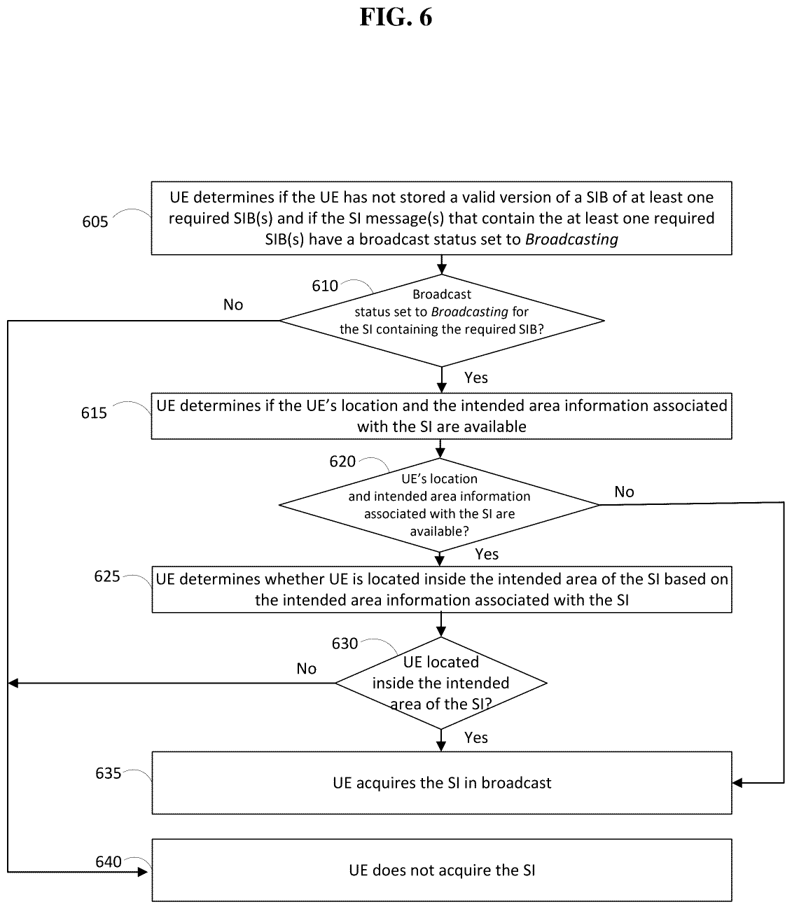

FIG. 6 shows a procedure for a UE to acquire location-based SI from a BS in accordance with an embodiment.

At operation 605, the UE determines if the UE has not stored a valid version of a SIB of one or several required SIB(s) and if the SI message(s) that contain the at least one required SIB(s) have a broadcast status set to Broadcasting.

At operation 610, if the UE determines the broadcast status is set to Broadcasting for the SI message(s) that contain the at least one required SIB(s), the procedure proceeds to operation 615.

Otherwise, if the UE determines the broadcast status is not set to Broadcasting (i.e., broadcast status is set to notBroadcasting) for the SI message(s) that contain the at least one required SIB(s), the procedure proceeds to operation 640, where the UE does not acquire the SI.

At operation 615, the UE determines if the UE's location and the intended area information associated with the SI are available. In one embodiment, the UE may acquire its location by global navigation satellite system (GNSS). In one embodiment, the UE may acquire the intended area information for the SI in MIB or SIB1 or other SIB(s) (e.g., in si-SchedulingInfo in SIB1). In one embodiment, the intended area information for the SI may be indicated by a mapping relation between each SIB and corresponding one or multiple intended area ID(s). Each intended area ID may represent a geographic area. If one or multiple intended area ID(s) are indicated for a SIB of SI, the SI is intended for the geographic area represented by the intended area ID(s).

In one embodiment, the intended area ID and the related geographic area information may be provisioned in uSIM, or conveyed in SIB (e.g., in MIB or SIB1 or other SIB). For example, the intended geographic area, each identified by an area ID, may be described by circle(s) and/or polygon(s). A circle is indicated by centre coordinates (e.g., reference location) and a radius. The centre coordinates may be signalled as a bit string, in one of the various formats of ellipsoid point defined in 3GPP Specification TS37.355 (e.g., Ellipsoid-Point, Ellipsoid-PointWithUncertaintyCircle, EllipsoidPointWithUncertaintyEllipse, EllipsoidPointWithAltitude, EllipsoidPointWithAltitude AndUncertaintyEllipsoid). The first/leftmost bit of the first octet contains the most significant bit. The radius indicates a distance from the centre coordinates, which may be signalled as an integer value in a unit of meter. A polygon is indicated by a list of polygon points with at least 3 points as defined in 3GPP Specification TS 37.355, where each point is indicated by an ellipsoid point (e.g., Ellipsoid-Point) as defined in 3GPP Specification TS 37.355.

In one embodiment, the intended area ID and the related geographic area may be derived by the UE based on the UE's location, a pre-defined rule of zone area, and/or relevant parameters. For example, each geographic area may be defined as a rectangular zone. The UE may determine the intended area ID for a geographic area based on the UE's location. For example, the broadcast service area ID is calculated by ID=y′×Nx+x′ in Equation 1 shown previously, where x′=ceil(x/L) mod Nx; y′=ceil(y/W) mod Ny; x and y are the longitude and latitude of the UE's location; L, W are the length and width of each zone, respectively; and Nx, Ny are the number of zones in length and width respectively. The UE may obtain its location by GNSS. L, W, Nx, and Ny may be pre-configured in MIB or SIB1 or pre-defined in standard specification or provisioned in uSIM.

At operation 620, if the UE determines the UE's location and the intended area information associated with the SI are available, the procedure proceeds to operation 625.

At operation 625, the UE determines whether it is located inside the intended area of the SI based on the UE's location and the intended area information associated with the SI.

At operation 630, if the UE determines it is located inside the intended area of the SI, the procedure proceeds to operation 635 to acquire the SI in broadcast.

Back at operation 620, if the UE determines the UE's location or the intended area information associated with the SI are not available, the procedure also proceeds to operation 635 to acquire the SI in broadcast.

Otherwise, at operation 630, if the UE determines it is located outside the intended area of the SI, the UE proceeds to operation 640, where the UE does not acquire the SI since the UE is outside the area targeted by the SI.

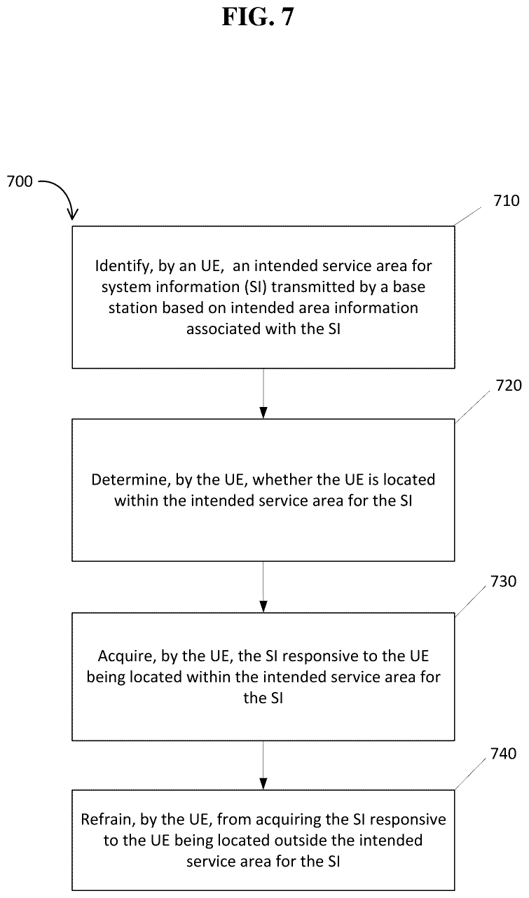

FIG. 7 shows an example process 700 for a UE to acquire location-based SI in accordance with an embodiment. For explanatory and illustration purposes, the example processes 700 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 7, the process 700 may begin in operation 710. In operation 710, a UE (e.g., a processor of the UE) identifies an intended service area for SI transmitted by a base station based on intended area information associated with the SI. In one embodiment, the SI includes one or more system information blocks (SIBs). The intended area information for the SI may include a mapping between each of the SIBs and one or more corresponding intended area IDs, where each of the one or more intended area IDs corresponding to an SIB represents an intended geographic service area of the SIB.

In operation 720, the UE determines whether the UE is located within the intended service area for the SI.

In operation 730, the UE acquires the SI responsive to the UE being located within the intended service area for the SI. In one embodiment, the UE acquires the SI when the intended service area for the SI is unavailable or a location of the UE is unavailable and the SI is broadcast by the base station. In one embodiment, when the SI is not broadcast by the base station and the UE is located within the intended service area for the SI, the UE triggers a request to the base station to transmit the SI. In one embodiment, the UE determine a configuration restriction prevents the UE from acquiring the SI when the SI is broadcast by the base station and the UE acquires the SI by dedicated signalling from the base station.

In operation 740, the UE refrains from acquiring the SI responsive to the UE being located outside the intended service area for the SI.

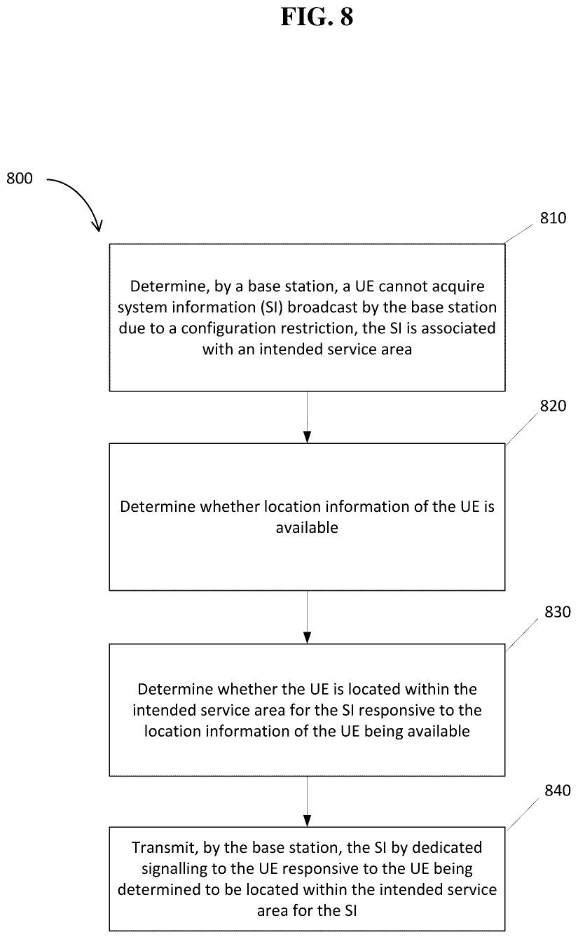

FIG. 8 shows an example process 800 for a BS to deliver location-based SI in accordance with an embodiment. For explanatory and illustration purposes, the example processes 800 may be performed by a UE (e.g., BS 101-103 as described with reference to FIG. 1). Although one or more operations are described or shown in particular sequential order, in other embodiments the operations may be rearranged in a different order, which may include performance of multiple operations in at least partially overlapping time periods.

Referring to FIG. 8, the process 800 may begin in operation 810. In operation 810, a BS (e.g., a processor of the BS) determines a UE cannot acquire SI broadcast by the BS due to a configuration restriction. The SI is associated with an intended service area. In one embodiment, the configuration restriction occurs when the UE does not have a search space to monitor paging or to acquire the SI when the UE is in the connected mode with the BS.

In operation 820, the BS determines whether location information of the UE is available.

In operation 830, the BS determines whether the UE is located within the intended service area for the SI responsive to the location information of the UE being available.

In operation 840, the BS transmits the SI by dedicated signalling to the UE responsive to the UE being determined to be located within the intended service area for the SI. In one embodiment, the BS transmits the SI by dedicated signalling to the UE when the BS determines the location information of the US is unavailable.

The disclosure presents signalling and acquisition procedures for location-based SI based on the relation between the intended area of the SI and a UE's location. The location-based SI targets an area smaller than a cell coverage area such as that of an NTN. In one embodiment, a network delivers a location-based SI based on the UE's location and the intended area of the SI via dedicated signalling to a UE. In one embodiment, the UE transmits a request for an on-demand area-specific SI to a network based on the UE's location and the intended area of the SI. In one embodiment, the UE acquires broadcast area-specific SI based on the UE location and the intended area of the SI.

Advantageously, the disclosed signalling and acquisition procedure facilitates the delivery, request, and use of location-based SI to support geo-fencing in NTN, allowing the SI to target a geographical area smaller than an NTN cell coverage and for UEs within an intended geographic area to receive SI intended for that geographic area.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) in a wireless network, the UE comprising:
a processor configured to:
identify an intended service area for system information (SI) transmitted by a base station based on intended area information associated with the SI;
determine whether the UE is located within the intended service area for the SI;
cause the UE to acquire the SI responsive to the UE being located within the intended service area for the SI; and
cause the UE to refrain from acquiring the SI responsive to the UE being located outside the intended service area for the SI.

2. The UE of claim 1, wherein the SI comprises one or more system information blocks (SIBs), wherein the intended area information for the SI comprises a mapping between each of the SIBs and one or more corresponding intended area IDs, and wherein each of the one or more intended area IDs corresponding to an SIB represents an intended geographic service area of the SIB.

3. The UE of claim 1, wherein to identify the intended service area for the SI and to determine whether the UE is located within the intended service area for the SI, the processor is configured to:
determine the intended service area for the SI is unavailable or a location of the UE is unavailable;
determine the SI is broadcast by the base station; and
cause the UE to acquire the SI.

4. The UE of claim 1, wherein to determine whether the UE is located within the intended service area for the SI, the processor is configured to:
determine the UE is located within the intended service area for the SI;
determine the SI is not broadcast by the base station; and
trigger a request to the base station to transmit the SI.

5. The UE of claim 4, wherein to trigger the request to the base station to transmit the SI, the processor is configured to:
trigger the request using a random access procedure.

6. The UE of claim 1, wherein to identify the intended service area for SI and to determine whether the UE is located within the intended service area for the SI, the processor is configured to:
determine the intended service area for the SI is unavailable or a location of the UE is unavailable;
determine the SI is not broadcast by the base station; and
trigger a request to the base station to transmit the SI.

7. The UE of claim 1, wherein to cause the UE to acquire the SI responsive to the UE being located within the intended service area for the SI, the processor is configured to:
determine a configuration restriction prevents the UE from acquiring the SI when the SI is broadcast by the base station; and
cause the UE to receive the SI by dedicated signalling from the base station.

8. The UE of claim 7, wherein to determine the configuration restriction prevents the UE from acquiring the SI, the processor is configured to:
determine the UE is in a connected mode with the base station; and
determine the UE does not have a search space to monitor paging or to acquire the SI.

9. The UE of claim 1, wherein the SI comprises:
a system information block (SIB) for a public warning system (PWS) message.

10. A base station in a wireless network, the base station comprising:
a processor configured to:
determine a user equipment (UE) cannot acquire system information (SI) broadcast by the base station due to a configuration restriction, the SI is associated with an intended service area;
determine whether location information of the UE is available;
determine whether the UE is located within the intended service area for the SI responsive to the location information of the UE being available; and
cause the base station to transmit the SI by dedicated signalling to the UE responsive to the UE being determined to be located within the intended service area for the SI.

11. The base station of claim 10, wherein to determine whether the location information of the UE is available, the processor is configured to:
determine the location information of the UE is unavailable; and
cause the base station to transmit the SI by dedicated signalling to the UE.

12. A method performed by a user equipment (UE) in a wireless network, the method comprising:
identifying an intended service area for system information (SI) transmitted by a base station based on intended area information associated with the SI;
determining whether the UE is located within the intended service area for the SI;
acquiring the SI responsive to the UE being located within the intended service area for the SI; and
refraining from acquiring the SI responsive to the UE being located outside the intended service area for the SI.

13. The method of claim 12, wherein the SI comprises one or more system information blocks (SIBs), wherein the intended area information for the SI comprises a mapping between each of the SIBs and one or more corresponding intended area IDs, and wherein each of the one or more intended area IDs corresponding to an SIB represents an intended geographic service area of the SIB.

14. The method of claim 12, wherein identifying the intended service area for the SI and determining whether the UE is located within the intended service area for the SI comprises:
determining the intended service area for the SI is unavailable or a location of the UE is unavailable;
determining the SI is broadcast by the base station; and
acquiring the SI.

15. The method of claim 12, wherein determining whether the UE is located within the intended service area for the SI comprises:
determining the UE is located within the intended service area for the SI;
determining the SI is not broadcast by the base station; and
triggering a request to the base station to transmit the SI.

16. The method of claim 15, wherein triggering the request to the base station to transmit the SI comprises:
triggering the request using a random access procedure.

17. The method of claim 12, wherein identifying an intended service area for the SI and determining whether the UE is located within the intended service area for the SI comprises:
determining the intended service area for the SI is unavailable or a location of the UE is unavailable;
determining the SI is not broadcast by the base station; and
triggering a request to the base station to transmit the SI.

18. The method of claim 12, wherein acquiring SI responsive to the UE being located within the intended service area for the SI comprises:
determining a configuration restriction prevents the UE from acquiring the SI when the SI is broadcast by the base station; and
receiving the SI by dedicated signalling from the base station.

19. The method of claim 18, wherein determining the configuration restriction prevents the UE from acquiring the SI comprises:
determining the UE is in a connected mode with the base station; and
determining the UE does not have a search space to monitor paging or to acquire the SI.

20. The method of claim 12, wherein the SI comprises:
a system information block (SIB) for a public warning system (PWS) message.
